(19) United States
(12) Patent Application Publication
(10) Pub. No.: US 2024/0119690 A1
(43) Pub. Date: Apr. 11, 2024

(54) STYLIZING REPRESENTATIONS IN IMMERSIVE REALITY APPLICATIONS

(71) Applicant: Meta Platforms Technologies, LLC, Menlo Park, CA (US)

(72) Inventors: Christopher John Ocampo, Dublin, CA (US); Stefano Zanetti, Vancouver (CA)

(21) Appl. No.: 18/481,917

(22) Filed: Oct. 5, 2023

Related U.S. Application Data
(60) Provisional application No. 63/378,436, filed on Oct. 5, 2022.

(51) Int. Cl. G06T 19/20; G06T 7/40; G06T 15/04; G06T 17/20

(52) U.S. Cl. CPC G06T 19/20; G06T 7/40; G06T 15/04; G06T 17/20; G06T 2207/10016; G06T 2207/10028; G06T 2207/20081; G06T 2207/20084; G06T 2207/30196; G06T 2219/2024

(57) ABSTRACT

A method and system for generating stylized representations in virtual/augmented reality applications. The method includes retrieving a two-dimensional (2D) image of a subject and a depth field associated with the 2D image. The method also includes generating a three-dimensional (3D) mesh based on the 2D image and the depth field. The method also includes generating a stylized texture field based on an analysis of the 2D image of the subject. The method also includes generating a 3D stylized model of the subject by enveloping the 3D mesh with the stylized texture field.

### CROSS-REFERENCE TO RELATED APPLICATIONS

The present disclosure is related and claims priority under 35 U.S.C. § 119(e) to U.S. Provisional Application No. 63/378,436, filed on Oct. 5, 2022, to Christopher John OCAMPO et al., entitled STYLIZING REALISTIC HUMAN REPRESENTATIONS IN VR/AR APPLICATIONS, the contents of which are hereby incorporated by reference, in their entirety, for all purposes.

### BACKGROUND

### Field

The present disclosure is generally related to the field of animated representation of human subjects in immersive reality applications. More specifically, the present disclosure is related to generating a three-dimensional (3D) stylized representation of a subject to add expressive content and eliminate artifacts in the immersive reality experience.

### Related Art

Conventionally, artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer).

Current models for human representation tend to have artifacts and gaps, which reduces an element of verisimilitude and liveliness desirable to bridge the gap across human representation in VR/AR applications.

### SUMMARY

The subject disclosure provides for systems and methods for generating stylized representations. One aspect of the present disclosure, the method includes retrieving a two-dimensional (2D) image of a subject and a depth field associated with the 2D image, generating a three-dimensional (3D) mesh based on the 2D image and the depth field, generating a stylized texture field based on an analysis of the 2D image of the subject, and generating a 3D stylized model of the subject by enveloping the 3D mesh with the stylized texture field.

Another aspect of the present disclosure relates to a system configured for generating stylized representations. The system includes one or more processors, and a memory storing instructions which, when executed by the one or more processors, cause the system to perform operations. The operations include to retrieve a 2D image of a subject, generate a depth field associated with the 2D image of the subject, generate a 3D mesh based on the 2D image and the depth field, generate a stylized texture field based on an analysis of the 2D image of the subject, and generate a 3D stylized model of the subject by enveloping the 3D mesh with the stylized texture field.

Yet another aspect of the present disclosure relates to a non-transient computer-readable storage medium having instructions embodied thereon, the instructions being executable by one or more processors to perform a method(s) for generating stylized representations described herein. The method may include retrieving a 2D image of a subject, generating a depth field associated with the 2D image of the subject, generating a 3D mesh based on the 2D image and the depth field, generating a stylized texture field based on an analysis of the 2D image of the subject, wherein the stylized texture field is a 2D representation of texture properties identified in the 2D image of the subject, and generating a 3D stylized model of the subject by enveloping the 3D mesh with the stylized texture field.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 illustrates a network architecture used to implement stylized representation generation, according to some embodiments.

FIG. 2 is a block diagram illustrating details of devices used in the architecture of FIG. 1, according to some embodiments.

FIGS. 3A-3B are block diagrams illustrating a representation pipeline used for generating a three-dimensional (3D) stylized representation of a subject, according to some embodiments.

FIGS. 4A-4D illustrates example outputs of a representation pipeline for generating a 3D stylized representation of a subject, according to some embodiments.

FIG. 5 illustrates a video capture of a subject and a resulting hologram, according to some embodiments.

FIG. 6 illustrates an example block diagram of a system for generating a 3D stylized representation, according to some embodiments.

FIG. 7 is a flowchart of a method for generating a 3D stylized representation, according to some embodiments.

FIG. 8 is a flowchart of a method for training a model, according to some embodiments.

FIG. 9 is a block diagram illustrating a computer system used to at least partially carry out one or more of operations in methods disclosed herein, according to some embodiments.

In the figures, elements having the same or similar reference numerals are associated with the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Embodiments of the disclosed technology may include or be implemented in conjunction with an artificial reality system. Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional (3D) effect to the viewer). Additionally, in some implementations, artificial reality may be associated with applications, products, accessories, services, or some combination thereof, that are, e.g., used to create or generate content (such as models and other virtual representations) in an artificial reality and/or used in combination with a user's environment. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

In the field of virtual reality (VR) and augmented reality (AR) applications, 3D representations of human (e.g., avatars) subjects are a computationally intensive task that may lead to gaps and artifacts which detract from the verisimilitude of the application. Additionally, from the point of view of expression, while progress has been steady with holograms and codec avatars, there is still a long way to go to achieve a desired fidelity. Real-time avatars are difficult to render with both self-expression and social presence. Even in cases where fidelity is satisfactory, it may be desirable to enhance some aspects and features of a subject, to add dramatism and emotional depth to a given scene.

Embodiments, as disclosed herein, address a problem in traditional artificial representation techniques tied to computer technology, namely, the technical problem(s) of generating realistically stylized models/representations in immersive reality applications. Embodiments are able to render more expressive avatars by taking aspects of a photorealistic representations and stylizing them (e.g., making representations more animated). The disclosed system solves this technical problem by providing a solution also rooted in computer technology, namely, by providing a pretrained stylistic neural network (NN) model designed to generate representations based on captured inputs. The disclosed subject technology further provides improvements to the functioning of the computer itself because it reduces the degree of complexity in texture mapping, and it improves processing, efficiency, and verisimilitude in artificial reality applications.

According to embodiments, stylized models are overlayed on a 3D mesh generated by a representation pipeline based on the stylistic NN model. The representation pipeline receives a two-dimensional (2D) input (e.g., live video feed or captured images, uploaded images, or content, etc.). The stylistic NN model may be a 2D-based algorithm including a generative adversarial network (GAN) applied to recreate stylized texture maps according to a desired stylistic training and envelope a 3D mesh forming a hologram with the texture maps.

In some embodiments, the stylistic NN model training may be based on a desired depiction style of the human figure (e.g., cartoons, a given artistic “school” or epoque). Once the model is trained, the degree of complexity of these texture maps is lower, thus enabling seamless real-time representations. The generated representations may be visually realistic and appear human-like.

In some embodiments, the generated representations may effectively represent emotions, expressivity, and appearance based on a subject(s) in an input image, and as such effectively communicates intent of the user through the representation. Expressivity may be conveyed via poses of a body and/or face of the generated representation through animated behaviors translating the subject's personality/emotions.

In some implementations, representations may be generated based on a moving subject (e.g., a user captured in real time at a client device). To patch gaps and inconsistencies resulting from subject motion or change of a direction of view, some embodiments include a buffering technique that superimposes several frames as the subject moves to correct for missing data on any one of the frames.

### Example Architecture

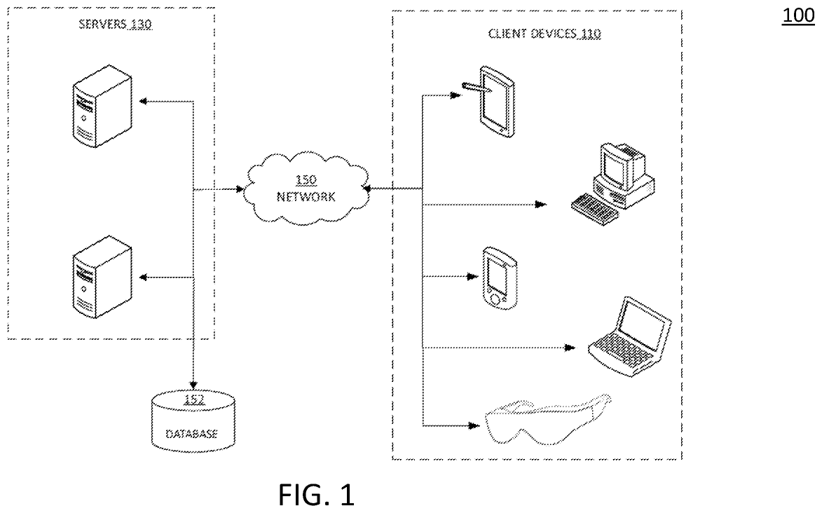

FIG. 1 illustrates a network architecture 100 used to generate stylized representations in AR/VR applications, according to some embodiments. Architecture 100 includes servers 130 communicatively coupled with client devices 110 and at least one database 152 over a network 150. The database 152 may store backup files from the AR/VR application, including images, videos, and metadata. Any one of servers 130 may host an AR/VR platform running on client devices 110, used by one or more of the participants in the network. Any one of servers 130 may be configured to host a memory including instructions which, when executed by a processor, cause the servers 130 to perform at least some of the steps in methods as disclosed herein. In some embodiments, the processor is configured to control a graphical user interface (GUI) for a user of one of client devices 110 accessing the AR/VR application. The servers 130 may be configured to train a machine learning model for performing a specific application. Accordingly, the processor may include a dashboard tool, configured to display components and graphic results to the user via the GUI. For purposes of load balancing, multiple servers 130 can host memories including instructions to one or more processors, and multiple servers 130 can host a history log and a database 152 including multiple training archives used for generating stylized representations. Moreover, in some embodiments, multiple users of client devices 110 may access the same server to run one or more machine learning models. In some embodiments, a single user with a single client device 110 may train multiple machine learning models running in parallel in one or more servers 130. Accordingly, client devices 110 may communicate with each other via network 150 and through access to one or more servers 130 and resources located therein.

Client devices 110 may include any one of a laptop computer, a desktop computer, or a mobile device such as a smart phone, a palm device, or a tablet device. In some embodiments, client devices 110 may include a headset for virtual reality (VR) applications, or a smart glass for augmented reality (AR) applications, or other wearable device, such that at least one participant may be running an immersive reality messaging platform installed therein. In that regard, the headset or smart glass may be paired to a smart phone for wireless communication with an AR/VR application installed in the smart phone, and from the smart phone, the headset or smart glass may communicate with server 130 via network 150.

Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

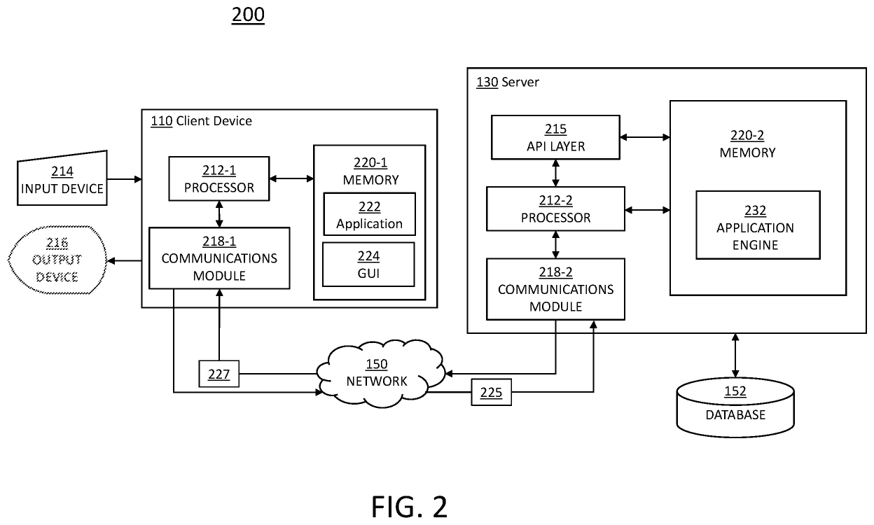

FIG. 2 is a block diagram 200 illustrating details of a client device 110 and a server 130 used in a network architecture as disclosed herein (e.g., architecture 100), according to some embodiments. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as requests, responses, messages, and commands to other devices on the network 150 in the form of datasets 225 and 227. Communications modules 218 can be, for example, modems or Ethernet cards, and may include radio hardware and software for wireless communications (e.g., via electromagnetic radiation, such as radiofrequency -RF-, near field communications -NFC-, Wi-Fi, and Bluetooth radio technology). Client device 110 may be coupled with an input device 214 and with an output device 216. Input device 214 may include a keyboard, a mouse, a pointer, or even a touch-screen display that a consumer may use to interact with client device 110. Likewise, output device 216 may include a display and a speaker with which the consumer may retrieve results from client device 110.

Client device 110 may also include a memory 220-1 and a processor 212-1. The processor 212-1 may be configured to execute instructions stored in a memory 220-1, and to cause client device 110 to perform at least some operations in methods consistent with the present disclosure. Memory 220-1 may further include an application 222 (e.g., VR/AR application) and GUI 224. The application 222 may include specific instructions which, when executed by processor 212-1, cause a dataset 227 from server 130 to be displayed for the user. In some embodiments, the application 222 runs on any operating system (OS) installed in client device 110. In some embodiments, the application 222 may be downloaded by the user from the server 130 and may be hosted by server 130. For example, application 222 may include an immersive reality environment in an AR/VR application, as disclosed herein. The application 222 includes specific instructions which, when executed by processor 212-1, cause a dataset 227 from server 130 to be displayed for the user. In the process of running application 222, client device 110 and server 130 may transmit data packets between each other, via communications modules 218 and network 150. For example, client device 110 may provide a data packet (e.g., dataset 225) to server 130 including an image of the user. Accordingly, server 130 may provide to client device 110 a data packet (e.g., dataset 225) including a 3D representation based on the image of the user.

In some embodiments, a participant may upload, with client device 110, a dataset 225 onto server 130. message/multimedia file being shared or transmitted through the network 150 or the server 130.

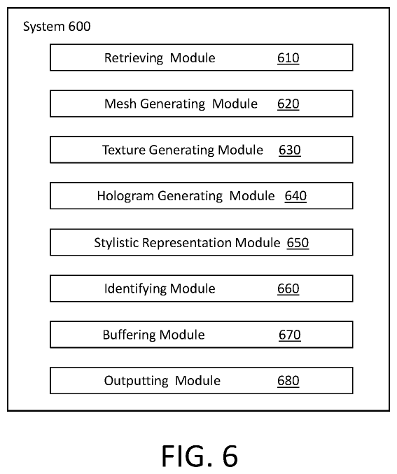

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes an application engine 232. Application engine 232 may share or provide features and resources to GUI 224, including multiple tools associated with training and using a stylistic model for generating stylistic representations in immersive reality applications. The user may access application engine 232 through application 222 installed in a memory 220-1 of client device 110. Accordingly, application 222 may be installed by server 130 and perform scripts and other routines provided by server 130 through any one of multiple tools. Execution of application 222 may be controlled by processor 212-1. Application engine 232 may include one or more modules configured to perform operations according to aspects of embodiments. Such modules are later described in detail with reference to at least FIG. 6.

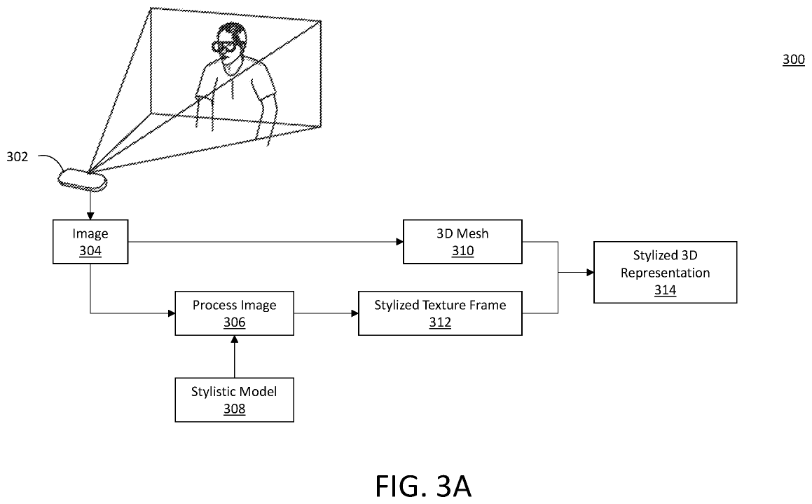

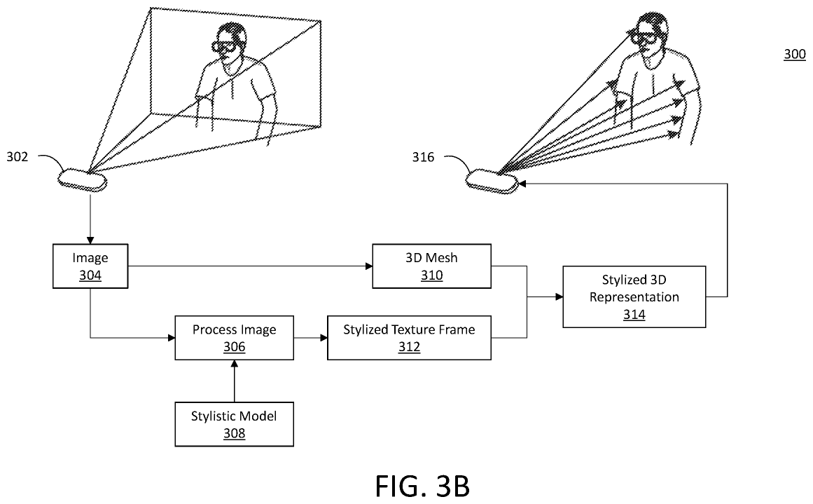

FIGS. 3A-3B are block diagrams illustrating a representation pipeline 300 used for generating a 3D stylized representation of a subject, according to some embodiments. In a training phase, a stylistic model 308 is trained on a stylized set of images (e.g., cartoon depictions of a human with a characteristic style). The set of images may include, but are not limited to, a visual dataset (e.g., large-scale training image datasets and video datasets), figures selected from a comic book, paintings, cartoons, and other artistic renditions of a human subject.

As shown in FIG. 3A, a first device 302 (e.g., client device 110) captures an image 304 of a person (i.e., the subject) in a 2D frame. The first device 302 may be a dedicated camera, or a webcam, or a mobile phone connected to secondary device in a VR/AR application. In some embodiments, the first device 302 may include a depth feature to capture depth for each red-green-blue (RGB) pixel in the 2D frame. The depth feature may include a pulsed light scanner, an ultrasound emitter, a light detection and ranging (LIDAR), or a fan ray emitter, irradiating the subject to determine depth features in the face and body.

In some embodiments, the first device 302 captures a video from which one or more frames are extracted to generate a single 2D representation frame of the person.

A 3D mesh 310 is generated based on a depth scan of the image 304. In some embodiments, the 2D, RGB frame is combined with the depth scan captured at the user device to generate the 3D mesh 310.

At process image 306, the image 304 is processed using the stylistic model 308 to generate stylized textures 312. The stylized textures 312 are 2D, stylized fields indicative of a texture property of the captured images. The stylistic model 308 generates stylized texture fields per RGB frame (e.g., image 304).

The stylized textures 312 are projected onto the 3D mesh 310 to generate a stylized 3D representation 314 of the subject having a stylized look. Expressions and emotions may be conveyed via poses of a body and/or face of the stylized 3D representation 314 based on the subject and animations and textures applied in accordance with the pre-trained model. In some embodiments, the stylized textures 312 are projected onto the 3D mesh 310 to generate a hologram. The hologram may be based on a set of images (e.g., RGB pixelated, 2D array) or a video collection and a depth scan of the subject. The stylized 3D representation 314 may be generated based on the hologram.

According to embodiments, the first device 302 may be capturing a moving subject. This may be at least one cause of artifacts in the hologram or stylized 3D representation 314. In order to combat this issue, artifacts in the hologram or stylized 3D representation 314 may be identified. A buffer may be applied to areas of the hologram or stylized 3D representation 314 identified as containing artifacts. The buffer may act as a texture patching layer for the areas with artifacts.

FIG. 3B includes a projector device 316 configured to output a view of the stylized 3D representation 314. The view may comprise of a projection of the representation with modified texture. In some implementations, the view of the stylized 3D representation 314 may be output on a flat screen or 2D surface, or in a 3D projection medium. In some implementations, the stylized 3D representation 314 may be projected to appear to overlay the subject in the real world and may be modified in real-time in accordance with changes in the subject. In some embodiments, the projector device 316 includes a display in the secondary device in the VR/AR application (e.g., in a VR or AR headset). In some implementations, the modified texture may be a result of buffering the stylized 3D representation 314 to adjust areas of the texture frame used to generate the stylized 3D representation 314 which includes artifacts.

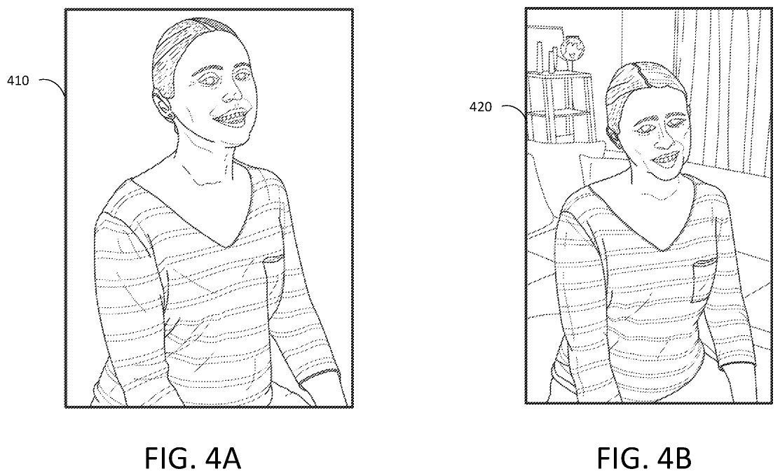

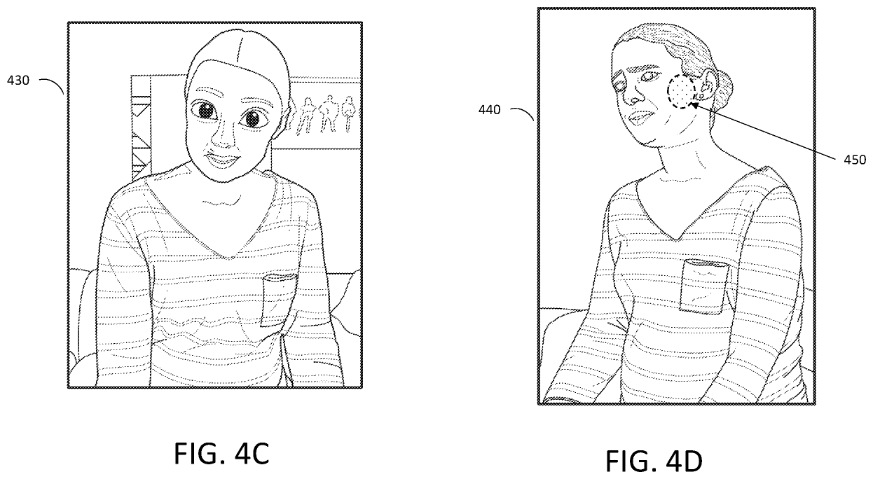

FIGS. 4A-4D illustrates example outputs of a representation pipeline for generating a 3D stylized representation of a subject, according to some embodiments. FIG. 4A illustrates a hologram 410 generated based a set of images and a depth scan of the subject. FIG. 4B illustrates a first stylized 3D representation 420 of the subject generated based on the hologram 410 in FIG. 4A. As shown in FIG. 4B, the first stylized 3D representation 420 show a more realistic nature of the subject. FIG. 4C illustrates a second stylized 3D representation 430 of the subject based on the hologram 410. As shown in FIG. 4C, the second stylized 3D representation 430 show a more cartoonish view of the subject, including big eyes and more defined and homogeneous facial features. FIG. 4D illustrates a third stylized 3D representation 440 that has been buffered to patch an area with texture artifacts, according to some embodiments. The patched area 450 may be generated by buffering images of the subject as it moves or rotates relatively to the capturing device (e.g., first device 302).

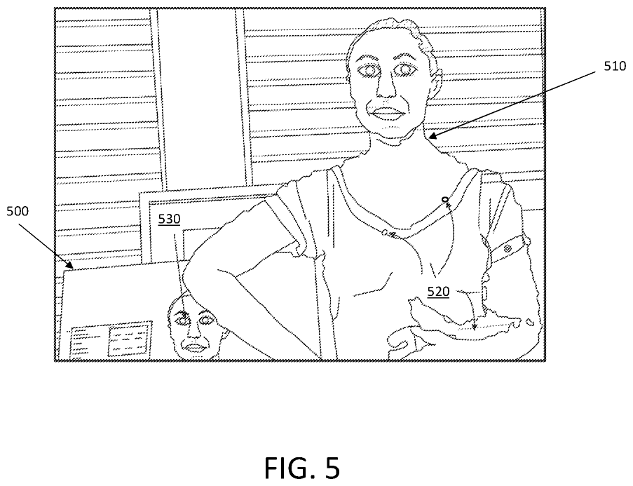

FIG. 5 illustrates a video capture of a subject and a resulting hologram, according to some embodiments. A video capturing device 500 may be capturing an input image or video of a subject 530. A hologram pipeline (e.g., representation pipeline 300) may generate hologram 510. In some embodiments, hologram 510 may be, for example, output by projector device 316. As can be seen, while the hologram is a fairly accurate representation of the subject, several artifacts 520 are visible as gaps in the subject's body. Some of these artifacts may arise from a movement of the subject's body during video capture, or simply due to a noisy and jittery video capture. In some implementations, the noisy hologram may be used in embodiments as disclosed herein to generate a smooth and accurate 3D representation of the subject. In some implementations, the buffer is applied to the hologram to patch areas where artifacts are identified, and then the 3D representation is generated based on the patched hologram. In other embodiments, wherein the 3D representation is generated directly from the texture fields and the 3D mesh, the buffer may be applied to the 3D representation as a post processing layer before it is output or displayed to the user.

FIG. 6 illustrates an example block diagram of a system 600 for generating a 3D stylized representation, according to one or more embodiments. The system 600 may include computing platform(s) including processor(s) that may be configured by machine-readable instructions. Machine-readable instructions may include one or more instruction modules. The instruction modules may include computer program modules. The instruction modules may include one or more of retrieving module 610, mesh generating module 620, texture generating module 630, hologram generating module 640, stylistic representation module 650, identifying module 660, buffering module 670, outputting module 680, and/or other instruction modules.

In some implementations, one or more of the modules 610, 620, 630, 640, 650, 660, 670, and 680 may be included in the client device 110 (e.g., in the application 222) and performed by one or more processors (e.g., processor 212-1). In some implementations one or more of the modules 610, 620, 630, 640, 650, 660, 670, and 680 may be included in the server 130 (e.g., in the application engine 232) and performed by one or more processors (e.g., processor 212-2). In some implementations, one or more of the modules 610, 620, 630, 640, 650, 660, 670, and 680 are included in and performed by a combination of the client device and the server.

The retrieving module 610 is configured to retrieve a 2D image of a subject and a depth field associated with the 2D image. The retrieving module 610 may be further configured to capture the 2D image of the subject and the depth field at a first client device including a camera and a depth capturing component. In some embodiments, the first client device is configured to scan (e.g., a pulsed radiation source) over a body of the subject to determine a depth for each pixel in the 2D image of the subject and generating the depth field based on the scan.

The mesh generating module 620 is configured to generate a mesh based on the 2D image and the depth field. In some embodiments, the mesh is a 3D mesh based on the depth scan of the subject.

The texture generating module 630 is configured to generate a stylized texture field based on an analysis of the 2D image of the subject. the stylized texture field is a 2D indicative of texture properties identified in the 2D image of the subject based on a NN model, such as a generative adversarial NN. The system 600 may further include training the generative adversarial NN based on a visual dataset, wherein the visual dataset includes stylized sample images of artistic representations of human beings, wherein the stylized texture field is generated based on the generative adversarial neural network.

In some embodiments, the first client device captures a video wherein a set of frames are extracted from the video. In some implementations, a 2D representation frame may be determined based on the set of frames used as the 2D image of the subject. In some implementations, the set of frames are used to generate a set of stylized texture fields.

The hologram generating module 640 is configured to generate a hologram of the subject by projecting stylized texture fields onto the mesh. The hologram may be based on a set of images of the subject and their corresponding set of stylized texture fields.

The stylistic representation module 650 is configured to generate a 3D stylized model of the subject by enveloping the mesh with the stylized texture field. In some embodiments, stylistic representation module 650 is further configured to generating the 3D stylized model based on the hologram.

The identifying module 660 is configured to identifying discontinuities (e.g., artifacts) in the stylized texture field.

The buffering module 670 is configured to buffer the 3D stylized model and patch the discontinuities in the stylized texture field to generate a texture modified 3D stylized model. In some implementations, the system 600 may be further configured to determine whether the subject is moving resulting in discontinuities in at least one of the stylized texture field or the 3D stylized model. When the subject is determined to be moving, the buffering module 670 may be further configured to path by the discontinuities superimposing multiple, consecutive two-dimensional images of the subject as the subject moves.

The outputting module 680 is configured to output a display of the 3D stylized model (or similarly, the modified 3D stylized model) to a second client device. The output may be a projection of the 3D stylized model in a virtual space or real space. In some implementations, the first and second client devices are the same device associated with an AR/VR application. In some implementations, the first device is a device (e.g., mobile device or computer) separate from the second device (e.g., a VR/AR headset).

Although FIG. 6 shows example blocks of the system 600, in some implementations, the system 600 may include additional blocks, fewer blocks, different blocks, or differently arranged blocks than those depicted in FIG. 6. Additionally, or alternatively, two or more of the blocks of the system may be combined.

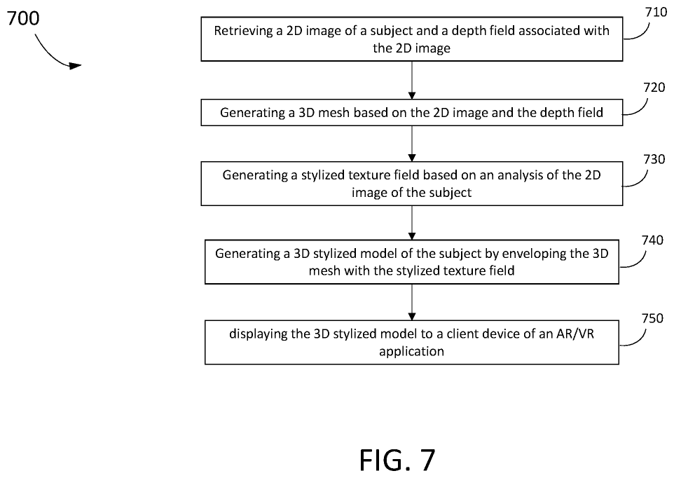

FIG. 7 is a flowchart of a method 700 for text-to-video generation, according to one or more embodiments.

In some embodiments, one or more of the operations/steps in method 700 may be performed by one or more of the modules 610, 620, 630, 640, 650, 660, 670, and 680. In some implementations, one or more operation blocks of FIG. 7 may be performed by a processor circuit executing instructions stored in a memory circuit, in a client device, a remote server or a database, communicatively coupled through a network. In some embodiments, methods consistent with the present disclosure may include at least one or more operations as in method 700 performed in a different order, simultaneously, quasi-simultaneously or overlapping in time.

As shown in FIG. 7, at operation 710, the method 700 includes retrieving a 2D image of a subject and a depth field associated with the 2D image. In some implementations, the method 700 may further include capturing the 2D image of the subject and the depth field at a client device including a camera and a depth capturing component. The method 700 may further include scanning, at the client device, a body of the subject to determine a depth for each pixel in the 2D image of the subject to generate the depth field.

At operation 720, the method 700 includes generating a 3D mesh based on the 2D image and the depth field.

At operation 730, the method 700 includes generating a stylized texture field based on an analysis of the 2D image of the subject. The stylized texture field is a 2D representation of texture properties identified in the 2D image of the subject based on a stylistic model. The stylistic model may be a generative adversarial neural network trained based on a visual dataset. The visual dataset may include stylized sample images of artistic representations of human beings.

At operation 740, the method 700 includes generating a 3D stylized model of the subject by enveloping the 3D mesh with the stylized texture field.

At operation 750, the method 700 includes displaying the 3D stylized model to a client device of an AR/VR application (e.g., communicably coupled to the AR/VR application). In some implementations, the client device may be a projector, or the like, and the 3D stylized model is projected onto the subject in the real world and/or visualized in the AR/VR application.

According to embodiments, the method 700 may further include generating a hologram of the subject by projecting stylized texture fields, based on a set of images of the subject, onto the 3D mesh. In some embodiments, the method 700 may further include generating the 3D stylized model based on the hologram.

According to embodiments, the method 700 may further include identifying discontinuities in the stylized texture field. Based on identifying discontinuities, the method 700 may further include buffering the 3D stylized model and patching the discontinuities in the stylized texture field by superimposing multiple, consecutive two-dimensional images of the subject as the subject moves. The method 700 may further include generating a modified 3D stylized model based on the buffering, and further displaying the modified 3D stylized model.

Although FIG. 7 shows example blocks of the method 700, in some implementations, the method 700 may include additional blocks, fewer blocks, different blocks, or differently arranged blocks than those depicted in FIG. 7. Additionally, or alternatively, two or more of the blocks of the method may be performed in parallel.

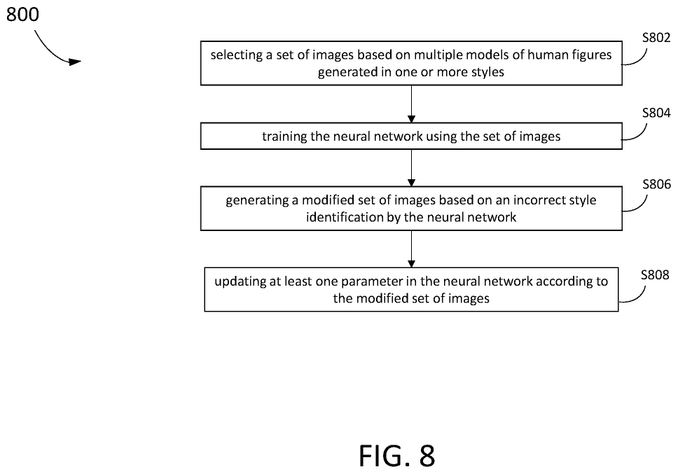

FIG. 8 illustrates steps in a method 800 for training a neural network for identifying a style in an image from a human subject. In some implementations, one or more operation blocks of FIG. 8 may be performed by a processor circuit executing instructions stored in a memory circuit, in a client device, a remote server or a database, communicatively coupled through a network. In some embodiments, methods consistent with the present disclosure may include at least one or more steps as in method 800 performed in a different order, simultaneously, quasi-simultaneously or overlapping in time.

Step 802 includes selecting a set of images based on multiple models of human figures generated in one or more styles. The set of images may be retrieved from a visual dataset comprising large-scale training image datasets, large-scale training video datasets, comic book, paintings, cartoons, other web-based sources, and other artistic renditions of human subjects. In some embodiments, step 802 includes selecting a first set of images based on the models of human figures generated in a first style and selecting a second set of images based on the models of human figures generated in a second style.

Step 804 includes training the neural network using the set of images. In some embodiments, step 804 includes training a first neural network to identify a first style and training a second neural network to identify a second style, wherein the modified set of images includes an image incorrectly identified by the first neural network and an image incorrectly identified by the second neural network.

Step 806 includes generating a modified set of images based on an incorrect style identification by the neural network. In some embodiments, step 806 includes adding images incorrectly identified by a first neural network in a first style and images incorrectly identified by a second neural network in a second style. Further, in some embodiments, updating at least one parameter in the neural network includes updating at least one parameter in the first neural network trained to identify the first style and updating at least one parameter in a second neural network trained to identify a second style.

Step 808 includes updating at least one parameter in the neural network according to the modified set of images.

Although FIG. 8 shows example blocks of the method 800, in some implementations, the method 800 may include additional blocks, fewer blocks, different blocks, or differently arranged blocks than those depicted in FIG. 8. Additionally, or alternatively, two or more of the blocks of the method may be performed in parallel.

### Hardware Overview

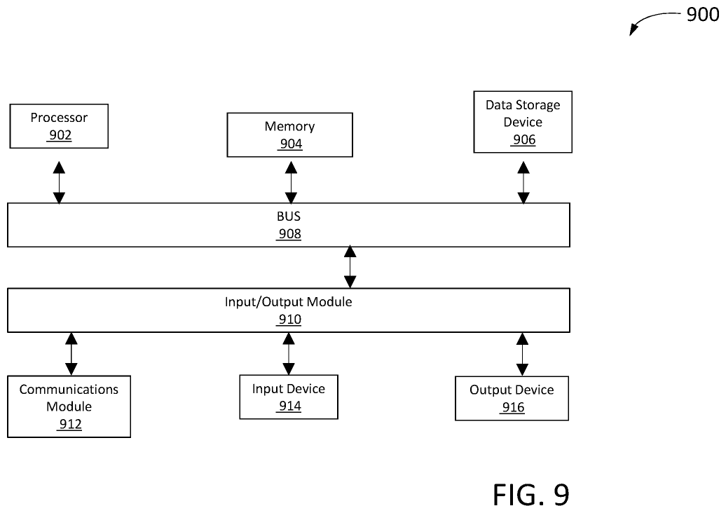

FIG. 9 is a block diagram illustrating an exemplary computer system 900 with which the client and server of FIGS. 1 and 2, and method(s) described herein can be implemented. In certain aspects, the computer system 900 may be implemented using hardware or a combination of software and hardware, either in a dedicated server, or integrated into another entity, or distributed across multiple entities. Computer system 900 may include a desktop computer, a laptop computer, a tablet, a phablet, a smartphone, a feature phone, a server computer, or otherwise. A server computer may be located remotely in a data center or be stored locally.

Computer system 900 (e.g., client 110 and server 130) includes a bus 908 or other communication mechanism for communicating information, and a processor 902 (e.g., processors 212) coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904 (e.g., memories 220), such as a Random Access Memory (RAM), a Flash Memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, e.g., one or more modules of computer program instructions encoded on a computer-readable medium for execution by, or to control the operation of, the computer system 900, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. Input/output module 910 can be any input/output module. Exemplary input/output modules 910 include data ports such as USB ports. The input/output module 910 is configured to connect to a communications module 912. Exemplary communications modules 912 (e.g., communications modules 218) include networking interface cards, such as Ethernet cards and modems. In certain aspects, input/output module 910 is configured to connect to a plurality of devices, such as an input device 914 (e.g., input device 214) and/or an output device 916 (e.g., output device 216). Exemplary input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 916 include display devices, such as an LCD (liquid crystal display) monitor, for displaying information to the user.

According to one aspect of the present disclosure, the client device 110 and server 130 can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires forming bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, performed by at least one processor, for generating stylized representations, the method comprising:
retrieving a two-dimensional (2D) image of a subject and a depth field associated with the 2D image;
generating a three-dimensional (3D) mesh based on the 2D image and the depth field;
generating a stylized texture field based on an analysis of the 2D image of the subject; and
generating a 3D stylized model of the subject by enveloping the 3D mesh with the stylized texture field.

2. The computer-implemented method of claim 1, further comprising:
capturing the 2D image of the subject and the depth field at a client device including a camera and a depth capturing component.

3. The computer-implemented method of claim 1, further comprising:
scanning a body of the subject to determine a depth for each pixel in the 2D image of the subject; and
generating the depth field based on the scanning.

4. The computer-implemented method of claim 1, wherein the stylized texture field is a 2D representation of texture properties identified in the 2D image of the subject.

5. The computer-implemented method of claim 1, further comprising:
training a generative adversarial neural network based on a visual dataset, wherein the visual dataset includes stylized sample images of artistic representations of human beings, wherein the stylized texture field is generated based on the generative adversarial neural network.

6. The computer-implemented method of claim 1, further comprising:
generating a hologram of the subject by projecting stylized texture fields, based on a set of images of the subject, onto the 3D mesh; and
generating the 3D stylized model based on the hologram.

7. The computer-implemented method of claim 1, further comprising:
identifying a discontinuity in the stylized texture field;
buffering the 3D stylized model, the buffering including patching the discontinuity in the stylized texture field by superimposing multiple, consecutive two-dimensional images of the subject as the subject moves; and
generating a modified 3D stylized model based on the buffering.

8. The computer-implemented method of claim 1, further comprising:
capturing a video at a client device;
extracting a set of frames from the video; and
determining a 2D representation frame based on the set of frames.

9. The computer-implemented method of claim 1, further comprising:
displaying the 3D stylized model to a client device communicably coupled to a virtual/augmented reality application.

10. A system for generating stylized representations, the system comprising:
one or more processors; and
a memory storing instructions which, when executed by the one or more processors, cause the system to:
retrieve a two-dimensional (2D) image of a subject;
generate a depth field associated with the 2D image of the subject;
generate a three-dimensional (3D) mesh based on the 2D image and the depth field;
generate a stylized texture field based on an analysis of the 2D image of the subject; and
generate a 3D stylized model of the subject by enveloping the 3D mesh with the stylized texture field.

11. The system of claim 10, wherein the one or more processors further execute instructions to capture the 2D image of the subject and the depth field at a client device including a camera and a depth capturing component.

12. The system of claim 10, wherein the one or more processors further execute instructions to:
scan a body of the subject to determine a depth for each pixel in the 2D image of the subject; and
generate the depth field based on the scan.

13. The system of claim 10, wherein the stylized texture field is a 2D representation of texture properties identified in the 2D image of the subject.

14. The system of claim 10, wherein the one or more processors further execute instructions to:
train a generative adversarial neural network based on a visual dataset, wherein the visual dataset includes stylized sample images of artistic representations of human beings, and the stylized texture field is generated based on the generative adversarial neural network.

15. The system of claim 10, wherein the one or more processors further execute instructions to:
generate a hologram of the subject by projecting stylized texture fields, based on a set of images of the subject, onto the 3D mesh; and
generate the 3D stylized model based on the hologram.

16. The system of claim 10, wherein the one or more processors further execute instructions to:
identify a discontinuity in the stylized texture field;
buffer the 3D stylized model, the buffer including patching the discontinuity in the stylized texture field by superimposing multiple, consecutive two-dimensional images of the subject as the subject moves; and
generate a modified 3D stylized model based on the buffering.

17. The system of claim 10, wherein the one or more processors further execute instructions to display the 3D stylized model to a client device communicably coupled to a virtual/augmented reality application.

18. A non-transient computer-readable storage medium having instructions embodied thereon, the instructions being executable by one or more processors to perform a method for generating stylized representations, the method comprising:
retrieving a two-dimensional (2D) image of a subject;
generating a depth field associated with the 2D image of the subject;
generating a three-dimensional (3D) mesh based on the 2D image and the depth field;
generating a stylized texture field based on an analysis of the 2D image of the subject, wherein the stylized texture field is a 2D representation of texture properties identified in the 2D image of the subject; and
generating a 3D stylized model of the subject by enveloping the 3D mesh with the stylized texture field.

19. The non-transient computer-readable storage medium of claim 18, further comprising:
generating a hologram of the subject by projecting stylized texture fields, based on a set of images of the subject, onto the 3D mesh; and
generating the 3D stylized model based on the hologram.

20. The non-transient computer-readable storage medium of claim 18, further comprising:
identifying a discontinuity in the stylized texture field;
buffering the 3D stylized model, the buffering including patching the discontinuity in the stylized texture field by superimposing multiple, consecutive two-dimensional images of the subject as the subject moves; and
generating a modified 3D stylized model based on the buffering.
